(19) United States
(12) Patent Application Publication
(10) Pub. No.: US 2006/0176360 A1
(43) Pub. Date: Aug. 10, 2006

(54) Thermal printing mechanism, in particularly applicable to payment terminals

(75) Inventor: Denis Montagutelli, Angers (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: APS ENGINEERING, PARIS (FR)

(21) Appl. No.: 10/508,519

(22) PCT Filed: Mar. 19, 2003
(86) PCT No.: PCT/FR03/00874

§ 371 Date: Jun. 20, 2005

(30) Foreign Application Priority Data
Mar. 21, 2002 (FR) 02/03504

(51) Int. Cl. B41J 2/325

(52) U.S. Cl. 347/222

(57) ABSTRACT

The invention relates to a thermal printing mechanism, comprising a chassis (1) housing a motor (6) for driving a printable tape, a thermal printing head (4), a backup roller (5) and electronic control means (8). The chassis (1) is fitted with a rigidification plate (9) extending substantially over its length, said plate being made of metal, forms a motor supporting bracket (6) to which it is welded, to provide heat sinking means. Said plate (9) is moreover operated to support a spring for pushing the printing head (4) towards the back-up roller (5). The mechanism is controlled electronically by a flexible connector (8) which is linked to remote control means of the mechanism, and which is besides operated for evacuating the electrostatic charges.

The invention relates to the field of thermal printing machines. It is an object of the invention to provide a thermal printing mechanism notably applicable to payment terminals. The object of the invention is more particularly a chassis structure partaking of such mechanism.

Thermal printing mechanisms are known, comprising a chassis housing mainly a printable tape driving means, a thermal printing head, means for contacting the tape against the printing head, and electronic means for controlling and driving the dynamic members of the mechanisms. The tape driving means comprise a motor for driving the reserve of a tape roller. The latter circulates between the printing head and a back-up roller, the latter being driven into rotation by the motor, by dint of a gear train, for example. The means for contacting the tape against the printing head comprise currently an elastic member for pushing the printing head towards the back-up roller.

It should be noted at this stage of the description that a simple structure is sought for this type of mechanism, offering the possibility of rendering it consumable, in order to facilitate the maintenance of the printing machines to which it is applied, payment terminals notably. This structure simplification aims more particularly at limiting the consitutive elements as well as the assembly operations of the different members to one another. This structure simplicity also aims essentially at rendering the mechanisms as compact as possible, for obvious reasons of reduced space requirements.

It will be understood that the present invention falls into this framework of constraints, and of the design difficulties deriving therefrom.

An ancient prior art has suggested printing mechanisms essentially composed of metal elements, the chassis notably. Assembling the elements together Involves the use of fastening members, with a consequent increase in the assembly operations, and untimely high production cost as regards the compact and consumable character requested for this type of mechanism.

A more recent prior art has suggested chassis made of plastic material, enabling to meet these requirements easily, by mould-organisation of the chassis.

A problem raised by the realisation of a chassis made of plastic material lies in its fragility. Indeed, this type of chassis usually comprises a couple of strut-braced spaced lateral walls, which support the functional members of the mechanism. This fragility results notably from a flexibility of the lateral walls, which alters their being held at constant distance from one another. Therefore, it has been suggested, with a view to rigidifying the chassis, to fit with a rigidification plate extending substantially over its length. This plate is rendered interconnected and immobilised on the chassis between the lateral walls, in translation as well as in pivoting around itself.

One may also refer to the patent EP0969970 (APS ENGINEERING), which describes such a mechanism. It should be noted that according to this prior art, close to that of the invention examined, as well from the point of view of its structure as of the general problems to be solved, this rigidification pate is advantageously operated as a support for the electronic means intended for controlling and driving the dynamic members of the mechanism.

Besides, a problem to be solved for the thermal printing mechanisms lies in the heat sinking effect generated by the motor and In the presence of untimely electrostatic charges. Still, the use of chassis made of plastic material is little suited to the resolution of such problems, by involving specific arrangements to solve them, with detriment to the simplicity of the mechanism.

The aim of the present invention is to provide a thermal printing mechanism, and more particularly a chassis structure partaking of this mechanism, which offers a satisfactory compromise between solutions applied to the problems raised usually for these mechanisms and aforementioned.

The invention aims notably at providing such a mechanism which is as compact as possible, while being simple in its structure for reduced production cost, during fabrication as well as assembly, robust and with optimised faculties of heat sinking and evacuation of the electrostatic charges. The present invention provides more particularly a chassis supporting the functional members partaking of such a mechanism.

The inventive approach of the present invention consisted in a first step in reducing the volume of the motor member, which is decisive for the space requirements of the mechanism. For exemplification purposes, this reduction in the motor member is obtained by reducing its diameter, to bring this diameter back to a see ranging between 15 and 20% of the width of the printing mechanism, rather than of the order of 25% of that width as it is usually according to the prior art.

Then, there is the problem of the heat generated by the motor member, the more so important as its diameter is reduced. The inventive approach of the present invention has consisted in a second step in exploiting the rigidification plate of the chassis to which it is immobilised, in order to form a supporting bracket for the motor to which it is fixed by dirt of heat exchanging means. These heat exchanging means are advantageously simple welding fastening means. The rigidification plate, selected as a metal plate, forms thanks to these arrangements, means for sinking the heat generated by the motor.

There results from these arrangements that the general space requirements of the printing mechanism is reduced considerably with respect to those of the prior art, thanks to the reduction in diameter of the motor and to its fastening, by welding notably, to the rigidification plate.

There results also from these arrangements that these reduced space requirements does not affect the sensitive members of the mechanism by an untimely increase in the heat caused by the motor, thanks to the exploitation of the rigidification plate as a heat sinking member for said heat.

There results moreover a simplified structure of the mechanism, whereas the rigidification plate may be added to the chassis, by embedding notably, after linking it by welding to the motor, an operation performed advantageously in a remote workshop. Finally, the rigidification plate being operated like a heat sinking member, these arrangements enable to fit the chassis with additional elements, specifically intended for that purpose.

Besides, such arrangements enable to simplify the overall carrying structure of the mechanism, a chassis cross-braced by the plate notably, by offering a rigidification plate partaking itself of the motor member, and more particularly of the cylindrical body housing its functional members. More precisely, the rigidification plate comprises an end wing, oriented transversally to its general extension, which forms a wall closing the cylindrical body of the motor member to which it is welded.

Building upon the initial inventive approach of the present invention, it is advantageously suggested to exploit moreover the rigidification plate, first of all to form a supporting bracket of the elastic member pushing the printing head towards the back-up roller.

In a second step, as the electronic controlling and driving means may not be supported by the rigidification plate by reason of its heat sinking function, the former comprises preferably transversally a longitudinal window for letting through a flexible connector, partaking of the electronic controlling means in order to link the dynamic members of the mechanism to the remote electronic controlling means.

More precisely regarding the arrangements relating to the elastic member, according to another aspect of the invention, said elastic member includes at least one leaf spring fitted with fastening means to the rigidification plate.

These arrangements are such that, on top of the simplified structure of the mechanism obtained, the push exerted onto the printing head towards the back-up roller is rendered homogeneous and reliable, whereas the leaf spring may advantageously extend, in a manner equivalent, continuous or discontinuous, over almost the whole length of the width of the mechanism, to adopt distant longitudinal bearing points against the printing head.

The fastening means of the leaf spring to the rigidification plate are advantageously formed by lateral rails provided on the spring, inside which are inserted jointly the corresponding longitudinal edges of the rigidification plate. These arrangements are such that the leaf spring is connected to the rigidification plate by a sliding and embedding process. It should also be noted that the rigidification plate extends preferably not only over the length of the chassis, but also on its width, in order on the one hand to provide a proper seat for the elastic member pushing the printing head towards the back-up roller, and on the other hand promote the rigidification of the chassis by cross-bracing both its lateral walls over the major portion of its depth.

Besides, the link between the elastic member and the rigidification plate is advantageously operated by using this elastic member as a locking means, for immobilising the rigidification plate on the chassis. To do so, the elastic member comprises an elastic embedding spoiler co-operating with a corresponding relief of the chassis. These arrangements are such that the placement of the rigidification plate, carrying the elastic member, causes flexion of the spoiler against its natural maintenance until it is inserted against the corresponding relief of the chassis. This relief forms a stop against the return of the spoiler to its natural position, in order to oppose the spontaneous retraction, possibly voluntary retraction, of the rigidification plate.

More precisely still, and by reference to another aspect of the invention, there is selected an arrangement of the electronic controlling means including the flexible connector aforementioned, which extends across the window with which is fitted the rigidification plate.

There also derives, not only preservation of the electronic controlling means of the heat generated by the motor, but also a gain in the space requirements of the mechanism. This gain in space requirements is obtained more particularly by moving the electronic controlling means away beyond the printing mechanism, on the chassis of the printing machine notably.

The use of flexible connector for the transmission of the driving information enables not only this remote placement, but also to free the inner volume of the chassis, for making it available for the reception of the other members of the mechanisms and/or for reducing said volume, in order consequently to reduce the global space requirements of the mechanism.

According to another aspect of the present invention, the chassis is preferably obtained by moulding a plastic material, simplifying thereby its realisation, and comprises reliefs for the embedding and fastening process, on the one hand on the side of the motor member and the ends of the back-up roller and of the printing head, and on the other hand, of the rigidification plate.

Thanks to the arrangements of the invention, this realisation of the chassis in a plastic material does not oppose, however, another aspect of the invention, which lies in grounding the members of the mechanism liable to transport electrostatic charges. Indeed, the printing head comprises currently a supporting bracket for a metal head whereon is deposited a ceramic substrate. Besides, the mechanism is preferably fitted with a metal paper guide, advantageously formed by cutting/folding a metal plate. There derives that all the meal members of the mechanism are in electrostatic contact after one another, notably staring from the paper guide, the printing head, the back-up roller by dint of the paper, the elastic pushing member, the rigidification plate and the motor member. The flexible connector, according to another aspect of its use, is advantageously applied to transport these electrostatic charges towards a reference potential, placed beyond the mechanism and notably towards the electronic controlling means supported by the machine.

It will be noted finally that the arrangements which have just been described should be taken into consideration, individually as well as in combination, as regards the results obtained pertaining to each of these arrangements or to their combinations.

The present invention will be better understood and relevant details thereof will appear in the following description of a preferred embodiment, in relation with the figures on the appended drawings, wherein:

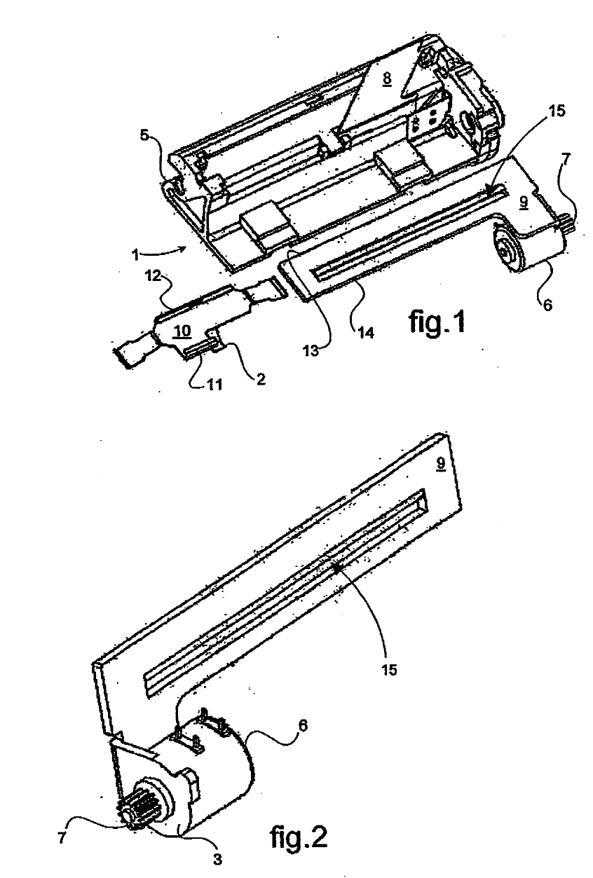

FIG. 1 is an exploded partial view of a thermal printing mechanism according to a preferred embodiment of the invention.

FIG. 2 is a perspective view illustrating a rigidification plate supporting a motor, partaking of the device represented on the previous figure.

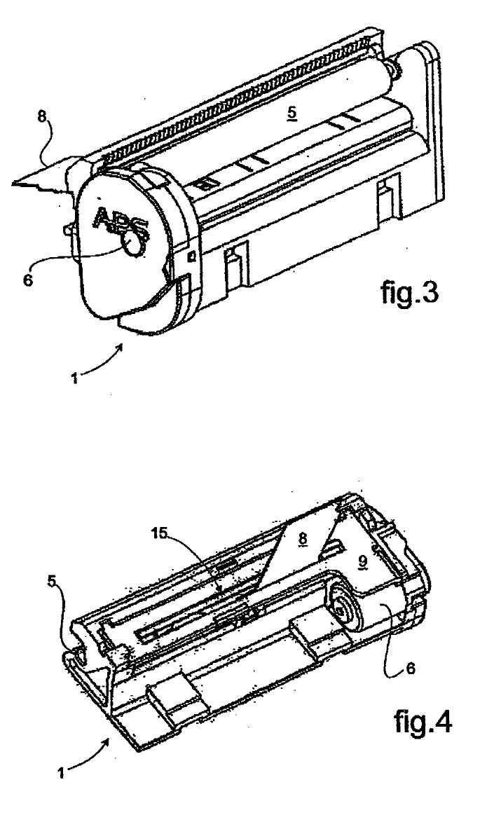

FIG. 3 is a perspective view of the mechanism represented on FIG. 1.

FIG. 4 is a partial view of the mechanism represented as assembled on FIG. 1.

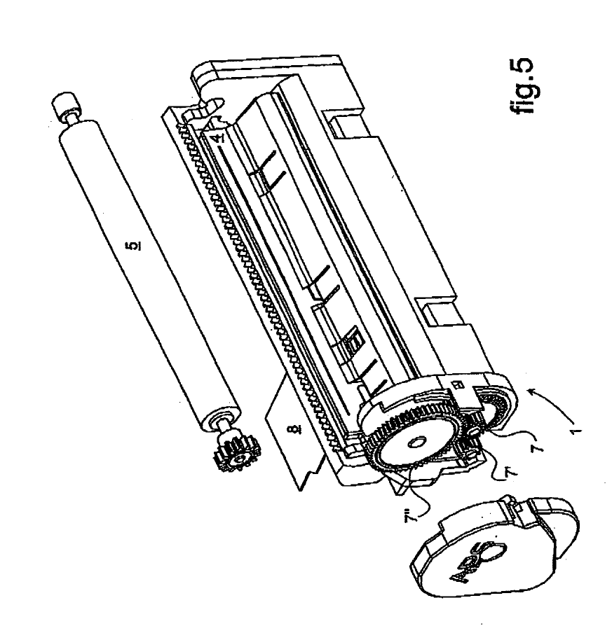

FIG. 5 Is a perspective partially exploded view of the mechanism represented on FIG. 1.

On the figures, a thermal printing mechanism comprises mainly:
a) A chassis 1 carrying the functional members of the mechanism.
b) A thermal printing head 4, particularly visible on FIG. 5.
c) A back-up roller 5 against which abuts the printable tape by dint of the printing head 4. It will be noted that this tape, whereof the roller reserve is supported by a printing machine fitted with the mechanism of the invention, is not represented on the Figures.
d) A motor 6 for driving the printable tape by dint of the back-up roller 5, that it drives into rotation by means of a gear train 7, 7′, 7″. It will be noted that the displacement of the tape results from the rotation of the back-up 5 and of its elastic pinching between the latter and the printing head 4.
e) A flexible connector 8 for driving the dynamic members of the mechanism, and notably the implementation of the motor 6 driving the backup 5 and thermal means of the printing head 4.

Reliefs are provided in the chassis 1, by moulded reserves, for embedding-fastening of the motor 6, of the back-up roller 5, of the printing head 4 and of a rigidification plate 9. The latter 9 extends over almost both dimensions of the chassis, and supports the motor member 6

A leaf spring 10 is inserted by sliding on the rigidification plate 9, to which it is fixed by embedding using lateral rails 11 and 12 with which it is fitted. These rails co-operate with the external longitudinal edges 13 and 14 of the rigidification plate 9. This spring 10 is intended for exerting an elastic push against the printing head 4, towards the back-up roller 5 for pinching therebetween the printable tape. There will also be noted an elastic spoiler 2 enabling to lock the immobilisation of the rigidification plate 9 and the chassis 1. This spoiler 2 co-operates to this end with a stop relief provided on the chassis during moulding, not visible on the Figures.

The rigidification plate 9 finally comprises crosswise a window 15 for letting through the flexible connector 8.

It will be noted finally, on FIG. 2, more particularly, that the rigidification plate 9 comprises an end wing 3 perpendicular to its general extension. This end wing 3 forms a wall of the cylindrical body of the motor 6, to which the wing 3 is welded. It will be observed that advantageously the rigidification plate 9 and the end wing 3 included therein, are formed by cutting/folding a metal plate.

1. A thermal printing mechanism, comprising a chassis housing mainly a printable tape driving means, a thermal printing head, means for contacting the tape against the printing head, and electronic means for controlling the dynamic members of the mechanisms, the tape driving means comprising a motor for driving the reserve of a tape roller, the latter circulating between the printing head and a back-up roller driven into rotation by the motor, the means for contacting the tape against the printing head comprising an elastic member for pushing the printing head towards the back-up roller, the chassis being fitted with a rigidification plate extending substantially over its length, which is rendered interconnected and immobilised on the chassis in translation as well as in pivoting around itself, wherein the motor is fixed by heat exchanging means to the rigidification plate, which as a metal plate, forms means for sinking the heat generated by the motor.

2. A mechanism according to claim 1, wherein the motor is welded to the rigidification plate.

3. A mechanism according to claim 2, wherein the rigidification plate comprises an end wing oriented transversally to its general extension, which forms a wall closing the cylindrical body of the motor member to which it is welded.

4. A mechanism according to claim 1, wherein the rigidification plate forms a supporting bracket of the elastic member pushing the printing head towards the back-up roller.

5. A mechanism according to claim 4, wherein the elastic member includes at least one leaf spring fitted with fastening means to the rigidification plate.

6. A mechanism according to claim 5, wherein the fastening means of the leaf spring to the rigidification plate are formed by lateral rails on the spring, inside which are inserted jointly the corresponding longitudinal edges of the rigidification plate,
so that the leaf spring is connected to the rigidification plate by a sliding and embedding process.

7. A mechanism according to claim 5, wherein the elastic member forms as a locking means, for immobilising the rigidification plate on the chassis.

8. A mechanism according to claim 7, wherein the elastic member comprises an elastic embedding spoiler co-operating with a corresponding relief of the chassis, which forms a stop against the return of the spoiler to its natural position, in order to oppose the retraction of the rigidification plate.

9. A mechanism according to claim 5, wherein the leaf spring extends over almost the whole length of the width of the mechanism, to adopt distant longitudinal bearing points against the printing head.

10. A mechanism according to claim 1, wherein the rigidification plate comprises transversally a longitudinal window for letting through a flexible connector partaking of the electronic controlling means

11. A mechanism according to claim 10, wherein the printing head, the back-up roller, the elastic pushing member, the rigidification plate and the motor member being in electrostatic contact after one another, the flexible connector is advantageously applied to transport these electrostatic charges towards a reference potential, placed beyond the mechanism.

12. A mechanism according to claim 1, wherein the chassis is obtained by moulding and comprises reliefs, produced by reserves during moulding, for embedding fastening of the back-up roller, of the printing head, of the motor and of the rigidification plate.
